(19) United States
(12) Patent Application Publication
(10) Pub. No.: US 2015/0118071 A1
(43) Pub. Date: Apr. 30, 2015

(54) VACUUM GENERATOR

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: XIAO-YI WU, Jiashan (CN); WEI-GUI XU, Jiashan (CN); XIAO-HONG ZENG, Jiashan (CN)

(21) Appl. No.: 14/508,695

(22) Filed: Oct. 7, 2014

(30) Foreign Application Priority Data
Oct. 31, 2013 (CN) 2013206788279

(51) Int. Cl. F04F 5/52; B65G 47/91; F04F 5/46

(52) U.S. Cl. CPC F04F 5/52; F04F 5/461; B65G 47/91
USPC 417/187

(57) ABSTRACT

A vacuum generator includes a main body, and a nozzle body received in the intake pipe. The main body includes an intake pipe, an outlet pipe, and a vacuum pipe received in the main body. The outlet pipe can be in communication with the intake pipe, and the vacuum pipe can extend away from the intersection of the intake pipe and the outlet pipe. The nozzle body is threadedly attached to the intake pipe and the position of the nozzle body in the intake pipe can be adjustable.

### FIELD

The subject matter herein generally relates to product transportation.

### BACKGROUND

A vacuum generator is used in, for example, a conveying device capable of holding a work piece by air suction. In the conventional vacuum generator, a vacuum state or a negative pressure state is generated. The vacuum state is generated through a switching valve, which controls the supply of air to relieve a vacuum. A work piece is sucked to the vacuum port when the vacuum state is generated in the vacuum port.

### BRIEF DESCRIPTION OF THE DRAWINGS

Implementations of the present technology will now be described, by way of example only, with reference to the attached figures.

FIG. 1 is an isometric view of an embodiment of a vacuum generator.

FIG. 2 is an exploded perspective view of the vacuum generator of FIG. 1.

FIG. 3 is a cross-sectional view of the main body of the vacuum generator of FIG. 1.

FIG. 4 is a cross-sectional view of the vacuum generator taken along line IV-IV of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising”, when utilized, means “including, but not necessarily limited to”; it specifically indicates open-ended inclusion or membership in the so-described combination, group, series and the like.

The present disclosure describes a vacuum generator.

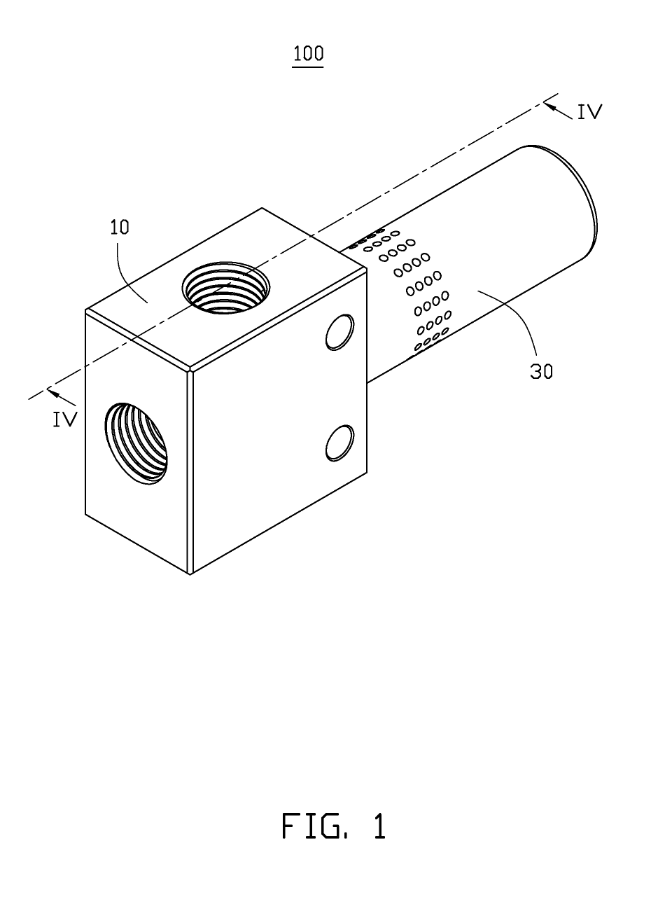

FIG. 1 illustrates an embodiment of a vacuum generator 100. The vacuum generator 100 can be coupled with a sucker (not shown), and can be configured to hold a workpiece. The vacuum generator 100 can include a main body 10 and a silencing device 30 assembled to one end surface of the main body 10. The main body 10 can be a substantially rectangular. The silencing device 30 can be a substantially hollow cylinder.

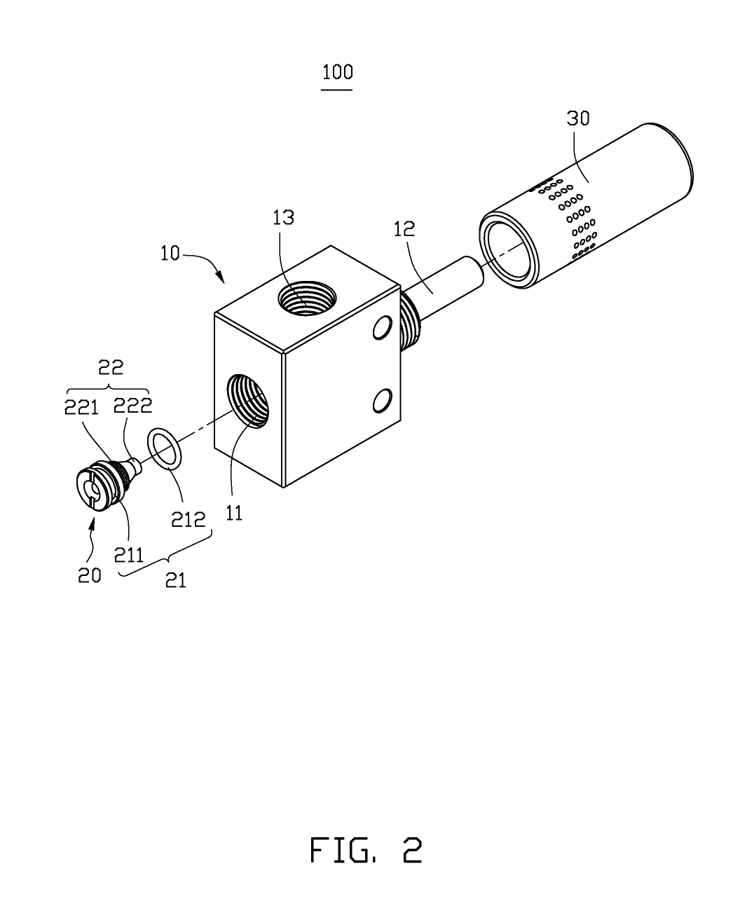

FIG. 2 illustrates that the main body 10 can include an intake pipe 11, an outlet pipe 12, and a vacuum pipe 13 received in the main body 10. The intake pipe 11 and the outlet pipe 12 can substantially pass through the main body 10. The outlet pipe 12 can be surrounded by, and attached to, the silencing device 30.

The vacuum generator 100 further includes a nozzle body 20 received in the main body 10. The nozzle body 20 can include a bottom portion 21 and a top portion 22. The bottom portion 21 can be a substantially hollow cylinder. A sealing groove 211 can be positioned on the peripheral wall of the bottom portion 21. The sealing groove 211 can be surrounded by, and attached to, a sealing ring 212. The sealing groove 211 and the sealing ring 212 can ensure gas tightness between the nozzle body 20 and the main body 10. A first thread 221 can be defined on the peripheral wall of the top portion 22. A nozzle 222 can be located at the end of the top portion 22, which can be substantially circular. A diameter of the nozzle 222 can be less than a diameter of the intake pipe 11.

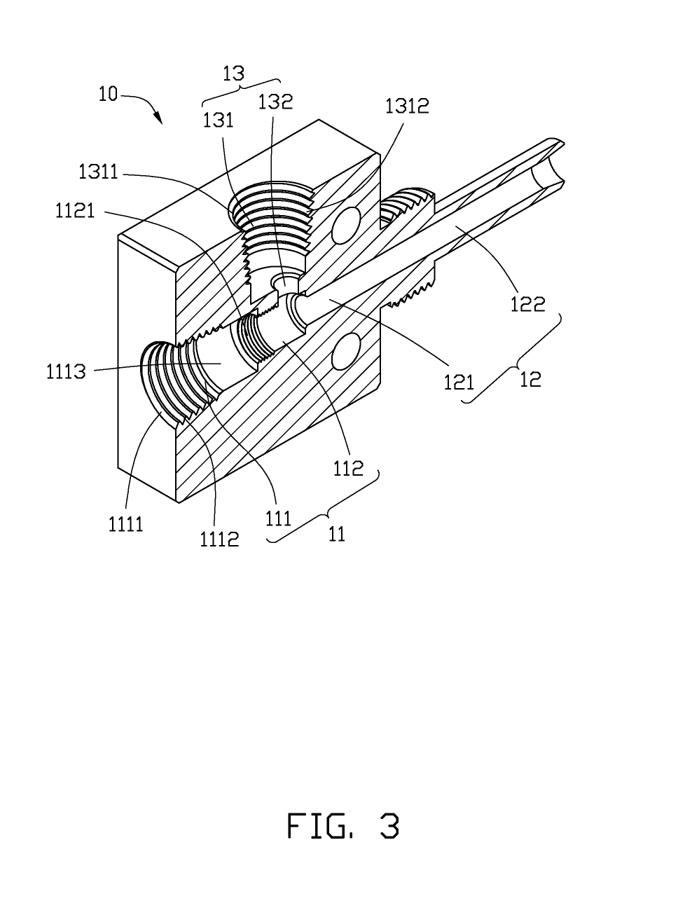

FIG. 3 illustrates that the intake pipe 11 is coaxial with the outlet pipe 12, and the intake pipe 11 can be coupled to the outlet pipe 12. The vacuum pipe 13 can extend away from the intersection of the intake pipe 11 and the outlet pipe 12. In the illustrated embodiment, the vacuum pipe 13 can be perpendicular to the central axis of the intake pipe 11 and the outlet pipe 12. In use, gas at high speed can flow into the main body 10 through the intake pipe 11, and can flow out from the outlet pipe 12. The vacuum pipe 13 can be generally connected with a sucker (not shown).

The intake pipe 11 can include a head portion 111, and a distal portion 112. An opening 1111 of the head portion 111 can be located on one side surface of the main body 10, and a diameter of the opening 1111 can be larger than an overall diameter of the intake pipe 111, thus ease of assembly of the nozzle body 20 into the intake pipe 11 can be improved. An inner thread 1112 can be defined on the inner surface of the head portion 111, and a pipe from outside can be assembled to the head portion 111 through the inner thread 1112. A columnar chamber 1113 can be formed between the inner thread 1112 and the distal portion 112.

The distal portion 112 can be substantially a cylinder, a second thread 1121 can be defined on the peripheral wall of the distal portion 112, and the distal portion 112 can be in communication with the head portion 111. A diameter of the distal portion 112 is less than a diameter of the head portion 111.

The outlet pipe 12 can be substantially a cylinder, and a diameter of the outlet pipe 12 can be less than the diameter of the distal portion 112. The outlet pipe 12 can include an inner pipe 121 received in the main body 10, and an outer pipe 122 exposed outside the main body 10.

The vacuum pipe 13 can include a first portion 131 and a second portion 132. The structure of the first portion 131 can be similar to the structure of the head portion 111, and the first portion 131 can include an opening 1311 located on the other side surface of the main body 10, an inner thread 1312 being defined on the peripheral wall of the first portion 131.

The second portion 132 can be substantially a cylinder, and a diameter of the second portion 132 is less than a diameter of the first portion 131. The second portion 132 can be in communication with the distal portion 112.

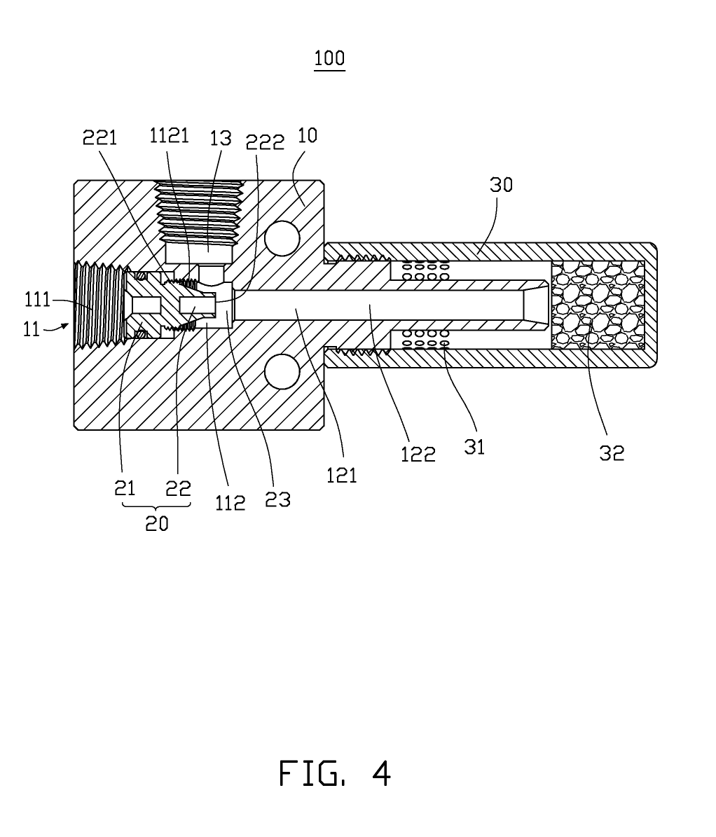

FIG. 4 illustrates that the nozzle body 20 can be wholly received in the intake pipe 11, and the bottom portion 21 can be received in the head portion 111. A diameter of the nozzle 222 can be less than a diameter of the inner pipe 121, so the movement of high speed air or gas between the nozzle 222 and the inner pipe 121 can be smooth.

A gap 23 can be formed between the nozzle 222 and the inner pipe 121, and the size of the gap 23 can be adjusted through rotating the nozzle body 20. The strength of the vacuum is governed by the gap 23, so the correct degree of vacuum is obtained through rotating the nozzle body 20.

The outer pipe 122 can be surrounded by and attached to the silencing device 30. A plurality of through holes 31 can be defined on the peripheral wall of the silencing device 30, the plurality of through holes 31 can change and lower the speed of the gas or air, and can lower environmental impact. A block of foam 32 can be received in the silencing device 30, and the block of foam 32 can be located away from the main body 10. The block of foam 32 can be opposite to an exit of the outer pipe 122, and the block of foam 32 can reduce the noise of high-speed gases.

In assembly, the sealing groove 211 can be surrounded by and attached to the sealing ring 212, and the nozzle body 20 can be assembled to the intake pipe 11 using the first thread 1121 and the second thread 221. The block of foam 32 can be received in the silencing device 30, and the silencing device 30 can surround and be attached to the outer pipe 122.

In use, gas from outside can flow into intake pipe 11, and flow out from the nozzle body 20. The gas out of the nozzle body 20 can flow into the inner pipe 121. At the same time, a vacuum can be formed around the gap 23, and the degree of vacuum can change with the size of the gap 23.

The first thread 1121 and the second thread 221 can allow the rotation of the nozzle body 20, the size of the gap 23 can be adjusted through rotating the nozzle body 20 to achieve the required degree of vacuum in the vacuum pipe 13. The silencing device 30 surrounding and attached to the outer pipe 122 can reduce noise.

The embodiments shown and described above are only examples. Many details are often found in the art such as the other features of a vacuum generator. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vacuum generator comprising:
a main body;
an intake pipe received in the main body;
an outlet pipe received in the main body and coupled to the intake pipe;
a vacuum pipe extending away from an intersection of the intake pipe and the outlet pipe; and
a nozzle body received in the intake pipe;
wherein the nozzle body is threadedly attached to the intake pipe, so that the position of the nozzle body in the intake pipe is adjustable.

2. The vacuum generator as claimed in claim 1, wherein the intake pipe comprises a head portion, and an inner thread is defined on the inner surface of the head portion.

3. The vacuum generator as claimed in claim 2, wherein the intake pipe further comprises a distal portion in communication with the head portion.

4. The vacuum generator as claimed in claim 3, wherein a diameter of the distal portion is less than a diameter of the head portion.

5. The vacuum generator as claimed in claim 3, wherein a thread is positioned on the peripheral wall of the distal portion.

6. The vacuum generator as claimed in claim 2, wherein the nozzle body comprises a bottom portion of the nozzle, and the bottom portion of the nozzle is received in the head portion.

7. The vacuum generator as claimed in claim 6, wherein a sealing groove is positioned on the peripheral wall of the bottom portion.

8. The vacuum generator as claimed in claim 7, wherein a sealing ring surrounds and is attached to the sealing groove.

9. The vacuum generator as claimed in claim 1, wherein the nozzle body further comprises a top portion, and a thread is defined on the peripheral wall of the top portion.

10. The vacuum generator as claimed in claim 9, wherein a nozzle is located at one end of the top portion, which is substantially circular, and a diameter of the nozzle is less than a diameter of the intake pipe.

11. The vacuum generator as claimed in claim 10, wherein the outlet pipe comprises an inner pipe received in the main body, and a gap is formed between the nozzle and the inner pipe.

12. The vacuum generator as claimed in claim 1, wherein the outlet pipe further comprises an outer pipe exposed outside the main body.

13. The vacuum generator as claimed in claim 12, wherein the outlet pipe is surrounded by and attached to a silencing device.

14. The vacuum generator as claimed in claim 13, wherein a plurality of through holes can be defined on the peripheral wall of the silencing device.

15. The vacuum generator as claimed in claim 13, wherein a block of foam can be received in the silencing device, and the block of foam is located away from the main body.

16. The vacuum generator as claimed in claim 1, wherein the vacuum pipe 13 comprises a first portion, and an inner thread is an inner thread is defined on the inner surface of first portion.

17. The vacuum generator as claimed in claim 16, wherein the vacuum pipe 13 comprises a second portion, and the second portion is in communication with the intake pipe.

18. The vacuum generator as claimed in claim 1, wherein the intake pipe is coaxial with the outlet pipe.

19. The vacuum generator as claimed in claim 18, wherein the vacuum pipe is perpendicular to a central axis of the intake pipe and the outlet pipe.
